(19) United States
(12) Patent Application Publication
(10) Pub. No.: US 2007/0215488 A1
(43) Pub. Date: Sep. 20, 2007

(54) Methods and apparatus for electroprocessing with recessed bias contact

(75) Inventors: Yan Wang, Sunnyvale, CA (US); Wei-Yung Hsu, Santa Clara, CA (US); Alain Duboust, Sunnyvale, CA (US); Antoine P. Manens, Sunnyvale, CA (US)

Correspondence Address: PATTERSON & SHERIDAN, LLP, 3040 POST OAK BOULEVARD, SUITE 1500, HOUSTON, TX, 77056, US

(73) Assignee: Applied Materials, Inc.

(21) Appl. No.: 11/377,990

(22) Filed: Mar. 17, 2006

(51) Int. Cl. C25C 7/02; B23H 5/06

(52) U.S. Cl. 205/662; 204/280

(57) ABSTRACT

A method and apparatus are provided for electroprocessing with recessed bias contact. In one embodiment, the apparatus includes a platen, a processing pad disposed on the platen and having at least a first aperture and a second aperture formed therethrough, a first electrode positioned under the processing pad and exposed to a polishing surface of the processing pad through the first aperture, wherein an upper surface of the first electrode is recessed from the polishing surface; a plurality of second electrodes exposed to the polishing surface through the second aperture, wherein upper surfaces of the second electrodes are recessed from the polishing surface, and an electrical circuit coupled to the first and second electrodes and configured to bias each of the second electrodes independently relative to the first electrode.

### BACKGROUND OF THE INVENTION

1. Field of the Invention

Embodiments of the present invention relate to a method and apparatus for electroprocessing a substrate, more specifically, to a method and apparatus for planarizing a substrate in an electroprocessing system.

2. Background of the Related Art

In the fabrication of integrated circuits and other electronic devices, multiple layers of conducting, semiconducting, and dielectric materials are deposited on or removed from a surface of a substrate. As layers of materials are sequentially deposited and removed, the substrate may become non-planar and require planarization, in which previously deposited material is removed from the substrate to form a generally even, planar or level surface. The process is useful in removing undesired surface topography and surface defects, such as rough surfaces, agglomerated materials, crystal lattice damage and scratches. The planarization process is also useful in forming features on the substrate by removing excess deposited material used to fill the features and to provide an even or level surface for subsequent deposition and/or other integrated circuit fabrication process.

Electrochemical Mechanical Planarization (ECMP) is one exemplary process which is used to remove materials from the substrate. ECMP techniques remove conductive material from a substrate surface by electrochemical dissolution while concurrently polishing the substrate with reduced mechanical abrasion compared to conventional CMP processes. The electrochemical dissolution is typically performed by applying an electrical bias between a cathode and substrate surface to remove conductive materials from a substrate surface into a surrounding electrolyte. During electrochemical dissolution, the substrate typically is placed in motion relative to a polishing pad to enhance the removal of material from the surface of the substrate. In one embodiment of an ECMP system, the electrical bias is applied by conductive elements projecting from a polishing pad. The conductive elements contact the substrate to electrically bias the conductive material being planarized on the substrate.

During polishing, the conductive elements on the polishing pad may not continuously and/or evenly contact the substrate, resulting in non-uniform electric fields across the substrate's diameter. The non-uniform distribution of the electrical bias prevents superior process uniformity and surface finish from being obtained. Moreover, while the substrate is in contact with the conductive elements of the polishing pad, mechanical stress may be generated which may promote surface damage, such as scratches and/or surface defects.

Therefore, there is a need for an improved polishing apparatus.

### SUMMARY OF THE INVENTION

Aspects of the invention generally provide a method and apparatus for electroprocessing with recessed bias contact. In one embodiment, the apparatus includes a platen, a processing pad disposed on the platen and having at least a first aperture and a second aperture formed therethrough, a first electrode positioned under the processing pad and exposed to a polishing surface of the processing pad through the first aperture, wherein an upper surface of the first electrode is recessed from the polishing surface, a plurality of second electrodes exposed to the polishing surface through the second aperture, wherein upper surfaces of the second electrodes are recessed from the polishing surface, and an electrical circuit coupled to the first and second electrodes and configured to bias each of the second electrodes independently relative to the first electrode.

In another embodiment, the apparatus includes a platen, a processing pad having a substrate polishing surface, a first electrode positioned under the processing pad, a second electrode, at least one anodic electrochemical cell formed in the processing pad disposed over the first electrode, and a plurality of cathodic electrochemical cells formed in the processing pad over the second electrode.

In yet another embodiment, a method for electro-chemical processing a substrate includes placing the substrate in contact with a polishing surface of a processing pad having a plurality of apertures formed in the surface, moving the substrate and the processing pad relative to each other, creating first conductive paths between anodes and the substrate through a first portion of the apertures, creating second conductive paths between cathodes and the substrate through second portions of the apertures, wherein the anodes and cathodes are defined in independently biased zones, and polishing the substrate by non-contact bias by the first and the second conductive paths.

### BRIEF DESCRIPTION OF THE DRAWINGS

A more particular description of the invention, briefly summarized above, may be had by reference to the embodiments thereof that are illustrated in the appended drawings. It is to be noted, however, that the appended drawings illustrate only typical embodiments of this invention and, therefore, are not to be considered limiting of its scope, for the invention may admit to other equally effective embodiments.

FIG. 1 is a sectional view of one embodiment of a processing cell of the invention;

FIG. 2 is a sectional view of one embodiment of a pad assembly;

FIG. 3 is an exploded top view of one embodiment of a pad assembly shown in FIG. 2; and

FIGS. 4A-4F are top and cross sectional views of different embodiments of electrodes having different electrode configuration according to the invention.

To facilitate understating, identical reference numerals have been used, where possible, to designate identical elements that are common to the figures. It is contemplated that elements and features of one embodiment may be beneficially incorporated in other embodiments without further recitation.

It is to be noted, however, that the appended drawings illustrate only exemplary embodiments of this invention and are therefore not to be considered limiting of its scope, for the invention may admit to other equally effective embodiments.

### DETAILED DESCRIPTION OF THE PREFERRED EMBODIMENT

Embodiments of the present invention generally relate to a method and apparatus for electroprocessing a substrate. The methods and apparatus described herein advantageously eliminate the physical contact with the conductive elements while the substrate is being placed in contact with a processing pad, thereby allowing the film damage being efficiently reduced, and improving process repeatability and reliability. Although the method and apparatus are described with reference to planarize a conductive layer, it is contemplated that the apparatus may be utilized for depositing material by reversing the applied current and appropriate electrodes.

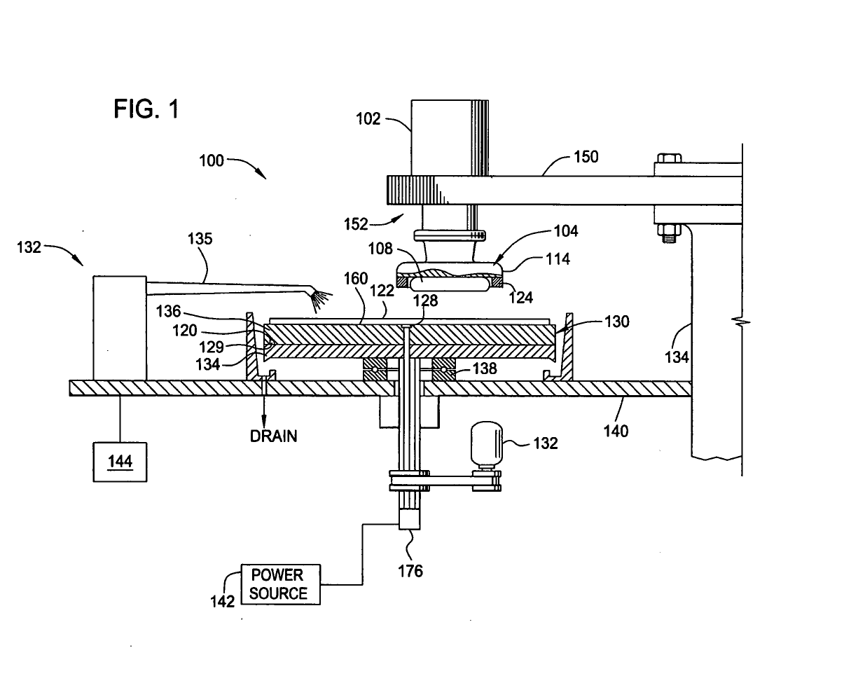

FIG. 1 depicts a sectional view of one embodiment of a process cell 100 of an electrochemical mechanical polishing system. The process cell 100 generally includes a platen assembly 130 and a planarizing head assembly 152. The planarizing head assembly 152 generally comprises a drive system 102 coupled to a planarizing head 104. The drive system 102 generally provides at least rotational motion to the planarizing head 104. The drive system 102 moves the planarizing head 104 with at least a rotary, orbital, sweep motion or combinations thereof.

A substrate 108 is retained in the planarizing head 104 and pressed against the platen assembly 130 during processing in a feature-side-down orientation. An process fluid is flowed onto the platen assembly 130 and in contact with the substrate's surface while the planarizing head 104 places the substrate 108 in contact with a pad assembly 122. The substrate 108 and the pad assembly 122 disposed on the platen assembly 130 are moved relative to each other to provide a polishing motion. The polishing motion generally comprises at least one motion defined by an orbital, rotary, linear, or curvilinear motion, or combinations thereof, among other motions. The polishing motion may be achieved by moving either or both of the planarizing head 104 and the platen assembly 130. The planarizing head 104 may be stationary or driven to provide at least a portion of the relative motion between the platen assembly 130 and the substrate 108 held by the planarizing head 104.

In one embodiment, the planarizing head may be a TITAN HEAD™ or TITAN PROFILER™ wafer carrier manufactured by Applied Materials, Inc. Generally, the planarizing head 104 comprises a housing 114 and retaining ring 124 that defines a center recess in which the substrate 108 is retained. The retaining ring 124 circumscribes the substrate 108 disposed within the planarizing head 104 to prevent the substrate from slipping out from under the planarizing head 104 while processing. The retaining ring 124 can be made of plastic materials such as PPS, PEEK, and the like, or conductive materials such as stainless steel, Cu, Au, Pd, and the like, or some combination thereof. It is further contemplated that a conductive retaining ring 124 may be electrically biased to control the electric field during processing. It is contemplated that other planarizing heads may be utilized.

The platen assembly 130 is rotationally disposed on a base 140. The platen assembly 130 is supported above the base 140 by a bearing 138 so that the platen assembly 130 may be rotated relative to the base 140. An area of the base 140 circumscribed by the bearing 138 is open and provides a conduit for the electrical, mechanical, pneumatic, control signals and connections communicating with the platen assembly 130.

Conventional bearings, rotary unions and slip rings, collectively referred to as rotary coupler 176, are provided such that electrical, mechanical, fluid, pneumatic, control signals and connections may be coupled between the base 140 and the rotating platen assembly 130. The platen assembly 130 is typically coupled to a motor 132 that provides the rotational motion to the platen assembly 130. The motor 132 controls the rotational speed and direction of the platen assembly 130.

The platen assembly 130 has an upper plate 136 and a lower plate 134. The upper plate 136 may be fabricated from a rigid material, such as a metal or rigid plastic, and in one embodiment, is fabricated from or coated with a dielectric material, such as CPVC. The upper plate 136 may have a circular, rectangular or other plane form. A top surface 160 of the upper plate 136 supports the processing pad assembly 122 thereon. The processing pad assembly 122 may be retained to the upper plate 136 by magnetic attraction, vacuum, clamps, adhesives and the like.

The lower plate 134 is generally fabricated from a rigid material, such as aluminum. In the embodiment depicted in FIG. 1, the upper and lower plates 136, 134 are coupled by a plurality of fasteners 129. Generally, a plurality of locating pins 120 (one is shown in FIG. 1) are disposed between the upper and lower plates 136, 134 to ensure alignment therebetween. The upper plate 136 and the lower plate 134 may optionally be fabricated from a single, unitary member.

A process fluid delivery system 132 is generally disposed adjacent the platen assembly 130. The process fluid delivery system 132 includes a nozzle or outlet 135 coupled to a process fluid source 144. The outlet 135 flows process fluid, such as electrolyte, from the process fluid source 144 to into the platen assembly 130. During processing, the process fluid generally provides an electrical path for biasing the substrate 108 and driving an electro-chemical process to remove and/or deposit material on the substrate 108. Alternatively, it is contemplated that the process fluid may be delivered from other portion of the system, such as the bottom of the platen 130, to the pad assembly 122 to provide a uniform distribution of the process fluid on the surface of the pad assembly.

One electrolyte that can be used for processing the substrate 108 facilitates electrochemical removal and/or deposition of metals such as copper, aluminum, tungsten, gold, silver or other materials from or onto the substrate 108. Electrolyte solutions may include commercially available electrolytes. For example, in copper containing material removal, the electrolyte may include sulfuric acid based electrolytes or phosphoric acid based electrolytes and potassium phosphate (K₃PO₄), or combinations thereof. The electrolyte may also contain derivatives of sulfuric acid based electrolytes, such as copper sulfate, and derivatives of phosphoric acid based electrolytes, such as copper phosphate. Electrolytes having perchloric acid-acetic acid solutions and derivatives thereof may also be used. Additionally, the invention contemplates using electrolyte compositions conventionally used in electroplating or electropolishing processes, including conventionally used electroplating or electropolishing additives, such as brighteners among others. In one aspect of the electrolyte solution, the electrolyte may be made of components (such as copper sulfate, for instance) having a concentration between about 0.2 and about 1.2 Molar of the solution.

As one example, copper sulfate (CuSO₄) can be used as the electrolyte. One source for electrolyte solutions used for electrochemical processes such as copper plating, copper anodic dissolution, or combinations thereof is Shipley Leonel, a division of Rohm and Haas, headquartered in Philadelphia, Pa., sold under the trade name ULTRAFILL 2000. Another example of an electrolyte is described in U.S. Pat. No. 6,863,797 by L. Sun, et al., entitled “ELECTROLYTE WITH GOOD PLANARIZATION CAPABILITY, HIGH REMOVAL RATE AND SMOOTH SURFACE FINISH FOR ELECTROCHEMICALLY CONTROLLED COPPER CMP”.

A power source 142 is coupled to the pad assembly 122 by electrical leads 128. The power source 142 applies an electrical bias to the pad assembly 122 to drive an electrochemical process as described further below. The leads 128 are routed through a rotary coupler 176 disposed below the platen assembly 130. The rotary coupler 176 facilitates continuous electrical connection between the power source 142 and the pad assembly 122 as the platen assembly 130 rotates.

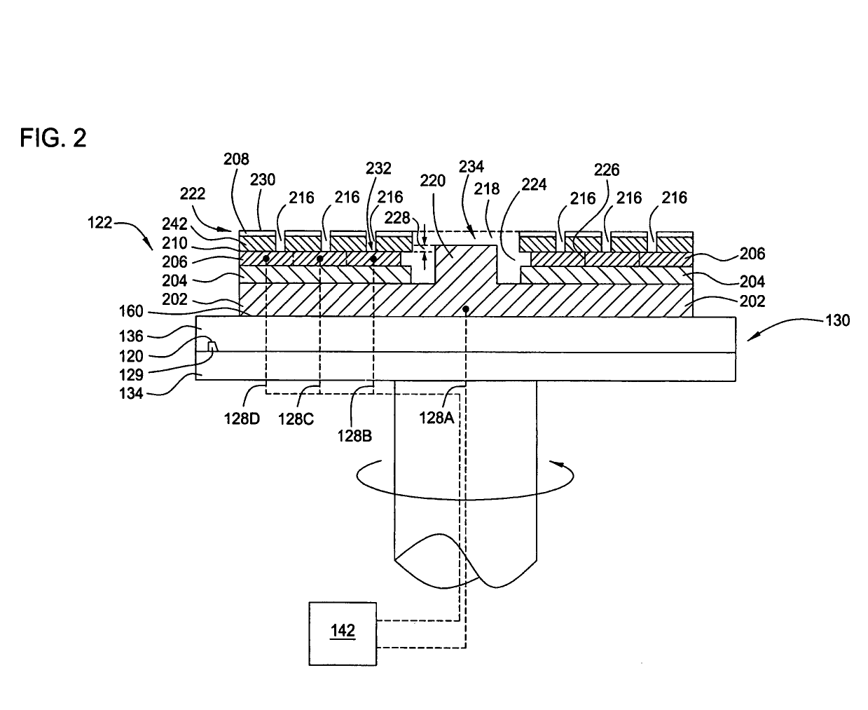

FIG. 2 depicts a sectional view of one embodiment of the pad assembly 122 that is removably disposed in the platen assembly 130. While the exemplary pad assembly 122 is described for an electrochemical-mechanical polishing (ECMP) process, the invention contemplates using the polishing assembly in other fabrication processes involving electrochemical activity. Examples of such processes using electrochemical activity include electrochemical deposition, which involves the pad assembly 122 being used to apply a bias to a substrate surface for depositing a conductive material without the use of a conventional substrate-contacting bias application apparatus, such as edge contacts, and electrochemical mechanical plating processes (ECMPP) that include a combination of electrochemical deposition and chemical mechanical polishing among others. As the pad assembly 122 includes elements comprising both an anode and cathode of an electrochemical cell, both the anode and cathode may be replaced individually and/or simultaneously by removing a used pad assembly 122 from the platen assembly 130 and inserting a new pad assembly 122 with fresh electrical components into the platen assembly 130. It is also contemplated that one or both of the anode and cathode may be separable from the pad assembly and/or separately coupled to the platen assembly 130.

The pad assembly 122 depicted in FIG. 2 includes a first electrode 202 and second electrode 206 having an insulating layer 204 disposed therebetween. A processing pad 222 is disposed on the second electrode 206 and includes a plurality of apertures 218, 216 formed therethrough. The first aperture 218 exposes at least a portion of the first electrode 202. The second aperture 216 exposes at least a portion of the second electrode 206. In one embodiment, the first electrode 202, the insulating layer 204, the second electrode 206 and the processing pad 222 may be secured together forming a unitary body that facilitates removal and replacement of the pad assembly 122 from the platen assembly 130. The first electrode 202, the insulating layer 204, the second electrode 206 and the processing pad 222 are adhered or bonded to one another by adhesives or other methods or combination thereof, including sewing, binding, heat staking, riveting, screwing and clamping among others. In another embodiment, the first electrode 202 may be coupled to or part of the platen assembly 130, thereby separated from the pad assembly 122. In this configuration, the insulating layer 204, the second electrode 206 and the processing pad 222 may be adhered or secured to one another by adhesive or any suitable methods and unitarily removable from the platen assembly 130. Alternatively, the insulating layer 204, the second electrode 206 and the processing pad 222 may be removed or replaced individually and/or be coupled in any combination.

In the embodiment depicted in FIG. 2, the first electrode 202 has at least a protrusion 220 projected from the center portion of the first electrode 202 partially into the first aperture 218. The first electrode 202 is configured as a non-consumable anode, and is generally fabricated from a highly conductive material, such as noble metals, stainless steel, aluminum and copper among others. For electrochemical removal processes, such as anodic dissolution, the electrode 202 may include a non-consumable electrode of a material other than the deposited material, such as platinum for copper dissolution. The non-consumable electrode is used in planarization processes combining both electrochemical deposition and removal. The first electrode 202 is coupled by lead 128A to the power source 142. The lead 128A may by coupled to the first electrode 202 in any number of methods that facilitate good electrical connection between the first electrode 202 and the power source 142, for example, by soldering, stacking, brazing, clamping, crimping, riveting, fastening, conductive adhesive or by other methods or devices that facilitate good electrical connection between the lead 128A and the first electrode 202.

The insulating layer 204 is disposed between the first electrode 202 and the second electrode 206 to keep the electrodes 202, 206 electrically isolated. The insulating layer 204 has at least one aperture 224 formed in the center portion of the layer 204 that allows the protrusion 220 of the first electrode 202 to extend therethrough. The insulating layer 204 is generally fabricated from a polymeric dielectric material, such as polyurethane.

The second electrode 206 is disposed on the top of the insulating layer 204. The second electrode 206 has at least one aperture formed in the center portion of the electrode 206 that is aligned with the aperture 224 of the insulating layer 204 to allow the protrusions 220 of the first electrode 202 to extend through the second electrode 206. The second electrode 206 is configured as a cathode, and is typically fabricated from a highly conductive material, such as noble metals, stainless steel, aluminum and copper among others. Alternatively, the second electrode 206 may be consumable. In one embodiment, as the second electrode 206 is readily replaceable with the processing pad 222 as a unit, allowing periodic replenishment of the second electrode 206 to be quickly and efficiently performed without substantially affecting processing throughput.

The second electrode 206 is coupled by lead 128B to the power source 142. The lead 128B may by coupled to the second electrode 206 in any number of methods that facilitate good electrical connection between the second electrode 206 and the power source 142 as stated above. In one embodiment, the second electrode 206 may be an undivided conductive element disposed on the insulating layer 204. In another embodiment, the second electrode 206 may be assembled by several conductive elements (as shown by phantom 226) configured as different conductive zones for applying different electrical voltage by various leads 128C-D (shown by phantom) coupled thereto so that current between each zone and the substrate may be independently controlled.

The processing pad 222 includes an upper polishing pad 208 and an optional intervening layer 242. For example, the intervening layers 242 may include at least one of a subpad and/or an interposed pad. In one embodiment, the subpad may be a urethane-based material, such as a foam urethane. In another embodiment, the interposed pad may be a sheet of mylar. The upper polishing pad 208 has a substantially dielectric polishing surface 230 and an opposing surface 210. The upper polishing pad 208 may be made of a polymeric material, such as polyurethane, polycarbonate, polyphenylene sulfide (PPS), or combinations thereof, and other polishing materials used in polishing wafer surfaces. An exemplary conventional material includes a fixed-abrasive polishing pad having high removal rate fixed-abrasive web material, for example, the SWR-521 fixed-abrasive polishing pad, commercially available from 3M of Minneapolis, Minn. Another exemplary conventional materials include, those found in the IC series of polishing media, for example polyurethane and polyurethane mixed with fillers, commercially available from Rodel Inc., of Phoenix, Ariz. The invention further contemplates the use of other conventional polishing materials, such as a layer of compressible dielectric material. The compressible material may include a conventional soft material, such as compressed felt fibers leached with urethane.

The polishing surface 230 is adapted to contact the substrate while processing. The polishing surface 230 may include grooves, embossing or other texturing to promote polishing performance. The processing pad 222 may be solid, impermeable to electrolyte, permeable to electrolyte or perforated.

The plurality of apertures 216, 218 formed through the processing pad 222 allows a process fluid disposed on the polishing surface 230 to fill the apertures 216, 218. As the process fluid is also in contact with the substrate, a conductive path is established between the electrodes 206, 202 across the substrate 108. The number, size, distribution, open area and pattern density of the apertures 216, 218 may be selected to obtain a desired processing result.

The height of the protrusion 220 projecting from the first electrode 202 is selected so that the top of the protrusion 220 is recessed below the polishing surface 230 but above the upper surface of the second electrode 206, as shown in arrow 228. As such, the electrodes 206, 202 do not contact the substrate 108 when processed on the processing pad 222. Beneficially, only one material (e.g., the processing pad 222) is in contact with the substrate, thereby enhancing process uniformity. Moreover, the absence of metal-containing substrate biasing elements in contact with the substrate reduces scratching potential. Additionally, as the electrodes 202, 206 are recessed from the polishing surface 230 of the processing pad 222, the polishing surface 230 of the processing pad 222 may be readily conditioned without damaging the electrodes 202 206, and/or creating a condition conducive to substrate damage or scratching. Thus, the life of the pad assembly 122 is advantageously increased without deteriorating electrical properties of the electrodes 202, 206.

Furthermore, the projected height of the protrusion 220, which stays higher than the position of the second electrode 206, encourages the dynamic flow of the processing fluid at the aperture 218 of the anode area, thereby efficiently circulating away the reacted byproducts and continuously irritating the electrochemical reactions to occur. In one embodiment, the protrusion 220 is recessed less than about 5 to about 50 mils, for example, from 10 to about 30 mils, from the polishing surface 230. In another embodiment, the protrusion 220 extends about 0 to about 150 mils, for example about 100 to about 145 mils, above the upper surface of the second electrode 206, as shown by arrow 228. The exposed surface of the second electrode 206 is recessed below the polishing surface 230 a distance of less than about 50 to about 150 mils, for example about 80 to 120 mils.

The apertures 216, 218 may be spaced or configured so that at least a portion of each of the apertures 216, 218 is periodically exposed to atmosphere or covered by the wafer during processing. In other words, the substrate 108, while substantially covering the apertures 216, 218 during processing, periodically uncover portions of the apertures 216, 218 to allow any gases present between the electrodes 206, 202 and substrate 108 to be released, thereby enhancing polishing stability and uniformity. Alternatively, the invention contemplates using a high rate of process fluid flow to flush out the gases present between electrodes 206, 202 and the substrate 108.

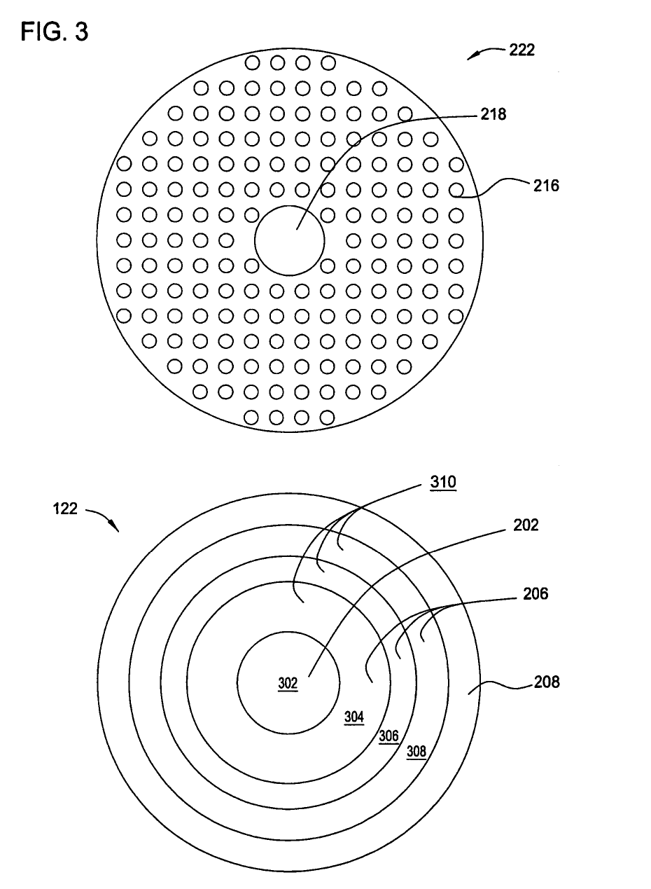

As depicted in the exploded top view of one embodiment of the pad assembly 122 depicted in FIG. 3, the electrodes disposed underneath the processing pad 222 may be arranged and divided into different zones to serve as either anodes or cathodes. Although the apertures 216, 218 shown in FIG. 3 are present as squares and circles, it is contemplated that the apertures may be selected as other suitable shape as need. At least one of current or voltage may be independently controlled in one zone relative to another zone. In one embodiment, the first electrode 202 is configured as an anode and defines a center zone 302 of the overall electrodes. The second electrode 206 is configured as cathode and is recessed in the recessed area 310 of the overall electrodes. Alternatively, the second electrode 206 may be either an undividedly unitary conductive elements 310 or be a separable conductive element divided with separated zones 304, 306, 308.

An exemplary mode of operation of the processing cell 100 is described primarily with reference to FIG. 1. In operation, the substrate 108 is retained in the planarizing head 104 and moved over the pad assembly 122 disposed in the platen assembly 130. The planarizing head 104 is lowered towards the platen assembly 130 to place the pad assembly 122 in contact with the substrate 108, or at least proximate thereto. Process fluid is supplied to the platen assembly 130 through the outlet 135 and flows onto the pad assembly 122. The process fluid fills the apertures 216, 218 in the processing pad 222 to establish a conductive path between the electrodes 202, 206 through the process fluid and across the substrate.

A bias voltage is applied from the power source 142 to the electrodes 202, 206 of the pad assembly 122 to drive an electrochemical polishing process that results in the removal of conductive material, such as copper, tungsten, or other material, disposed on the surface of the substrate 108. The bias may include the application of a voltage of about 15 volts or less to the substrate surface. In one embodiment, a voltage between about 0.1 volts and about 10 volts may be applied between the electrodes 202, 206 to remove copper-containing material from the substrate surface into the process fluid.

The bias applied to perform the electrochemical polishing process may be varied in power and application, depending on the user requirements in removing material from the substrate surface. The bias may also be applied by electrical pulse modulation techniques. In one embodiment, an electrical pulse modification technique includes applying a constant current density or voltage over the substrate for a first time period, then applying a constant reverse voltage over the substrate for a second time period, and repeating the first and second steps. For example, the electrical pulse modification technique may use a varying potential from between about −0.1 volts and about −20 volts to between about 0.1 volts and about 20 volts.

The substrate 108 and pad assembly 122 are moved relative to one another to uniformly polish the substrate surface. A contact force of about 6 psi or less is typically used to hold the substrate 108 against the pad assembly 122.

In one embodiment, a contact force of about 0.5 psi or less may be used when polishing substrates containing a layer of low dielectric constant material.

During polishing, the region in each aperture 216, 218 between the electrodes 206, 202 and the substrate 108 is filled with process fluid and becomes two separate electrochemical cells 232, 234 as bias is applied to each electrode 206, 202 from the power source 142. In the cell 232 above the second electrode 206, OH⁻ ions migrate towards the second electrode 206. H⁺ ions migrate to the metal surface (on the substrate). The electrons are supplied by the ionization process that simultaneously occurs in the cell 234 above the first electrode 202. In cell 234, the Cu or other metal film present on the surface of the substrate 108 loses electrons into the process fluid, and metal ions, such as H⁺, migrate to the first electrode 202. This double cell process completes the current loop, polishing the metal film on the substrate 108 without contacting the substrate with solid conductors. Additionally, different electrochemical process/byproducts may be presented in the cells 232, 234 according to different electrolytes used for the process.

Conductive materials can be removed from at least a portion of the substrate surface at a rate of up to at least about 15,000 Å/min. In one embodiment of the invention, where an 12,000 Å copper layer is processed, the removal rate is between about 100 Å/min and about 9,000 Å/min.

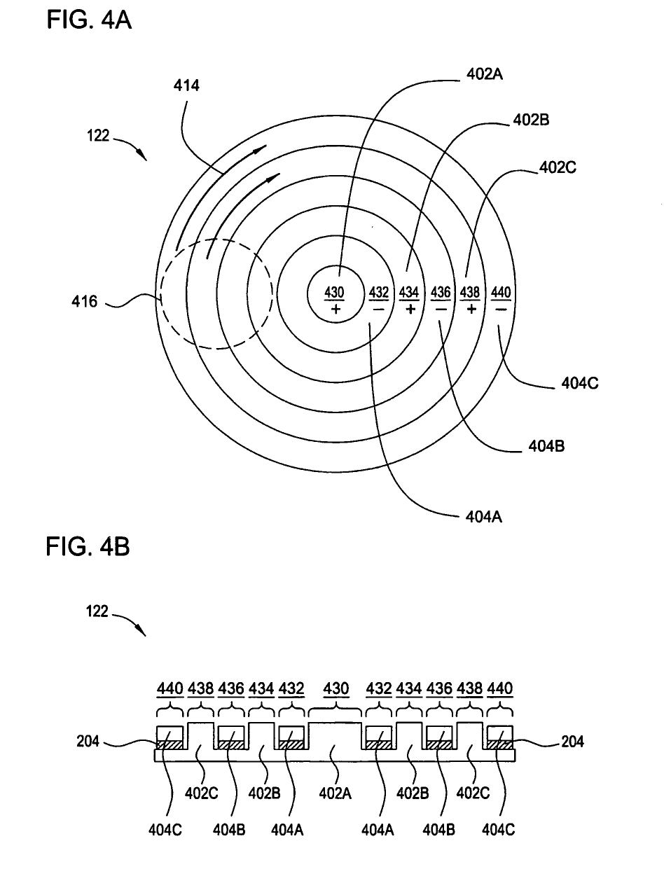

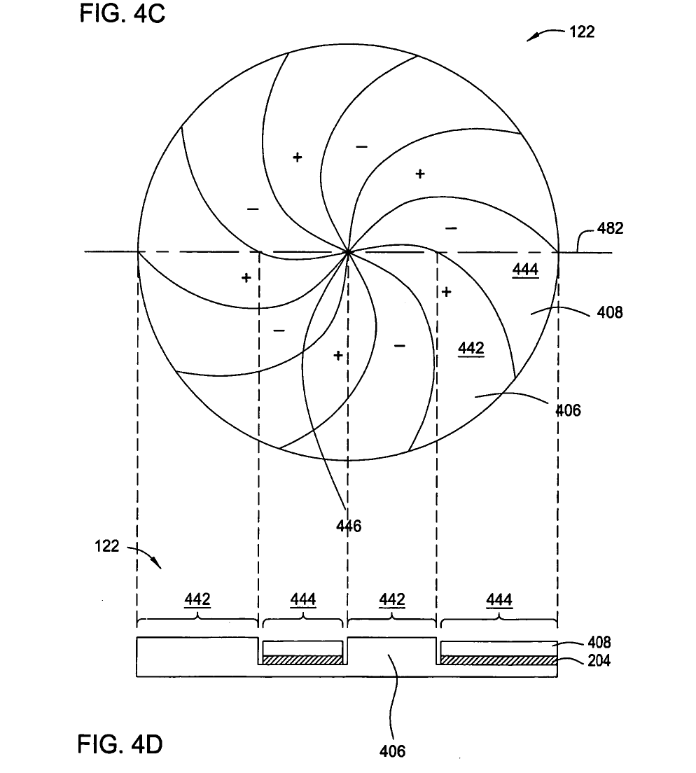

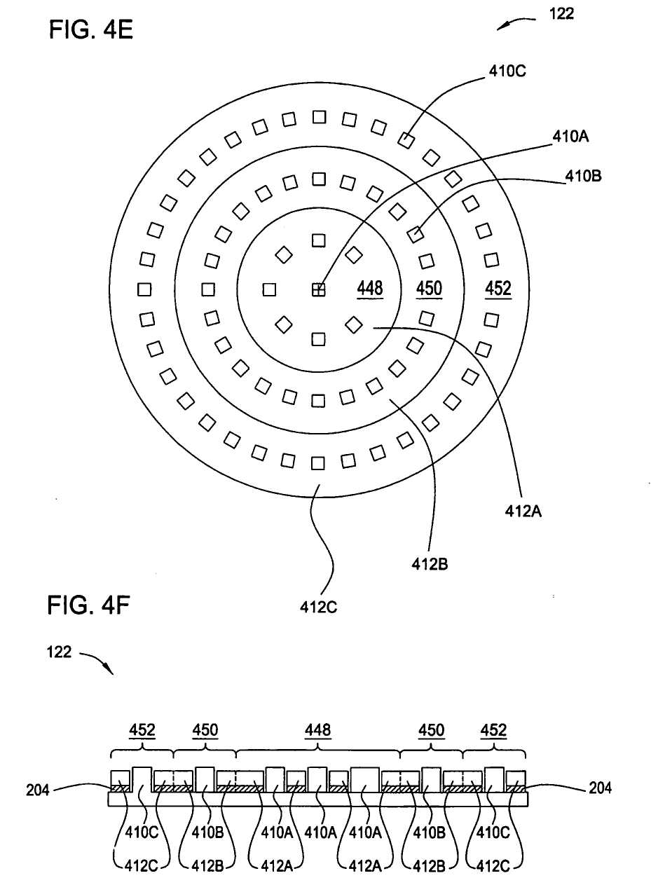

FIGS. 4A-4F depict top views and cross sectional views of different embodiments of the electrodes 202, 206 having different electrode configurations. FIGS. 4A and 4B depict top and cross sectional views of one embodiment of the present invention. A plurality of electrodes 402, 404 (shown as 402A-C, and 404A-C) are spaced to define different zones 430, 432, 434, 436, 438, 440. In one embodiment, the different zones 430, 432, 434, 436, 438, 440 are independently biasable zones. In another embodiment, the different zones 430, 432, 434, 436, 438, 440 are commonly connected to a single power source to be uniformly biased. In yet another embodiment, the different zones 430, 432, 434, 436, 438, 440 may be independently and/or uniformly biased as needed. At least one electrode 402 configured as anode and at least one electrode 404 configured as cathode are arranged to be spaced between one another. Voltage and/or current may be independently controlled when applied to the different electrodes 402, 404, so that the current passing through each zone 430, 432, 434, 436, 438, 440 may be independently controlled to optimize the polishing profile of the substrate. In one embodiment, the center zone 430 of the electrode 402A is configured as anode and the adjacent electrode 404A in zone 432 disposed circumscribed the center zone 430 is configured as a cathode. The electrode 402B in zone 434 is configured as another anode. The electrode 402B is spaced and circumscribes the electrode 404A in zone 432. Another electrode 404B is configured as another cathode in zone 436. The electrodes 404B is spaced from and circumscribes the electrode 402B in zone 434. More electrodes 402C, 404C may be successively arranged to define zones 438, 440. Additional electrodes may be incorporated as needed. It should be noted that the numbers of the divided zones, anodes, and cathodes may be selected variously as various polishing requirement.

The electrodes of anodes 402A, 402B, 402C and cathodes 404A, 404B, 404C are arranged in a manner that allows the substrate to be polished uniformly as the distribution and distances between cathodic and anodic cells may be controlled, for example, with uniform spacing, more anodic cells in one region, or more cathodic cells in another region, to obtain a desired processing result. As the substrate 416 rotating and sweeping across the processing pad 222 disposed above the electrodes, as shown by the arrows 414, the electrodes with anodes and cathodes distributed in different zones served as the double cells illustrated above to provide substantially uniform electrical profile that enhances the polishing uniformity on the substrate, thereby allowing the metal film on the substrate being polished without contacting the substrate with solid conductors.

FIG. 4C depicts a top view of another embodiment of the present invention. FIG. 4D depicts a cross sectional view taken along sectional line 482 of FIG. 4C. The electrodes are spaced to define independently biasable zones 442, 444 configured as either anodes 406 or cathodes 408 disposed beside one another radiated from the center portion 446 of the electrodes. In one embodiment, Voltage and/or current may be independently controlled when applied to the different electrodes 406, 408, so that the current passing through each zone 442, 444 may be independently controlled to optimize the polishing profile of the substrate. In another embodiment, the different zones 442, 444 may be commonly connected to a single power pole to be uniformly biased as needed. Each zone 442, 444 is configured to have substantially similar area. The distributions and numbers of the independently biasable zones configured as anodes and cathodes are controlled, for example, with uniform area, spacing, shape and similar amounts of cathodes and anodes, thereby allowing the substrate to be polished uniformly to obtain a desired processing result. The independently biasable zones that serve as anodes or cathodes complete the current loop and thus polish the metal film on the substrate 108 without physically contacting by solid conductors.

FIGS. 4E and 4F depict top and cross sectional views of yet another embodiment of the present invention. The electrodes 410, 412 (shown as 410A-C, 412A-C) are spaced to define zones 448, 450, 452. In one embodiment, voltage and/or current may be independently controlled when applied to the different electrodes 410, 412, so that the current passing through each zone 448, 450, 452 may be independently controlled to optimize the polishing profile of the substrate. In another embodiment, the different zones 450, 452 are commonly connected to a power pole to be uniformly biased as needed. The electrodes 412A, 412B, 412C are configured to define independently bias able zones 448, 450, 452. A plurality of apertures 410A, 410B, 410C configured as anodes are arranged to be uniformly dispose among the zones 448, 450, 452. The distribution, shape, numbers, directions and sizes of the apertures may be selected as needed. The cathodes 412A, 412B, 412C served by the independently biasable zones 448, 450, 452 and the anodes 410A, 410B, 410C disposed among the cathodes 412A, 412B, 412C complete the current loop and thus polish the metal film on the substrate 108 without physically contacting by solid conductors.

Therefore, the present invention substantially extends the life of electrode and processing pad by minimizing the physically and directly contact between the substrate and the conductive elements. Moreover, as the substrate is biased by the processing fluid, defects and damages associated with the substrate being in contact with a metallic biasing element is advantageously reduced. As such, the performance of electrochemical processing of the substrate is enhanced.

While the foregoing is directed to various embodiments of the invention, other and further embodiments of the invention may be devised without departing from the basic scope thereof, and the scope thereof is determined by the claims that follow.

What is claimed is:

1. Apparatus for processing a substrate comprising:
a platen;
a processing pad disposed on the platen and having at least a first aperture and a second aperture formed therethrough;
a first electrode positioned under the processing pad and exposed to a polishing surface of the processing pad through the first aperture, wherein an upper surface of the first electrode is recessed from the polishing surface;
a plurality of second electrodes exposed to the polishing surface through the second aperture, wherein upper surfaces of the second electrodes are recessed from the polishing surface; and
an electrical circuit coupled to the first and second electrodes and configured to bias each of the second electrodes independently relative to the first electrode.

2. The apparatus of claim 1, further comprising:
an insulating layer disposed between the first electrode and the second electrodes.

3. The apparatus of claim 1, further comprises:
a protrusion extending from the first electrode and into the first aperture.

4. The apparatus of the claim 3, wherein the protrusion of the first electrode further comprises:
a top surface recessed about 5 to about 50 mils from the polishing surface of the processing pad.

5. The apparatus of claim 1, wherein the first electrode further comprises:
a top surface recessed about 5 to about 80 mils from the polishing surface of the processing pad.

6. The apparatus of claim 1, wherein the second electrodes further comprise:
top surfaces respectively recessed about 50 to about 100 mils from the polishing surface of the processing pad.

7. The apparatus of claim 3, wherein a height of the protrusion extends about 30 to about 150 mils above an upper surface of the second electrodes.

8. The apparatus of claim 1, the first electrode is configured as an anode and coupled to a first pole of a power source, and the second electrodes are configured as cathodes and coupled to a second pole of a power source.

9. The apparatus of claim 1, wherein the processing pad further comprises:
a polymeric pad; and
a subpad coupled to the polymeric pad.

10. The apparatus of claim 1, wherein the processing pad is a fixed abrasive pad.

11. The apparatus of claim 1, wherein the first electrode and second electrodes define independently bias able zones.

12. The apparatus of claim 1, wherein a portion of the first electrode is circumscribed by the second electrodes.

13. The apparatus of claim 1, wherein the first electrode and the second electrodes are concentric.

14. The apparatus of claim 1, wherein the first electrodes and the second electrodes are arranged in alternating rings.

15. The apparatus of claim 1, wherein the first electrodes and the second electrodes are sequentially spaced in a radial configuration.

16. The apparatus of claim 1, wherein the second electrodes are positioned between the first electrode and the processing pad.

17. Apparatus for processing a substrate comprising:
a platen;
a processing pad disposed on the platen and having a substrate polishing surface;
a first electrode positioned under the processing pad;
a plurality of second electrodes disposed between the first electrode and the pad;
at least one anodic electrochemical cell formed in the processing pad disposed over the first electrode; and
a plurality of cathodic electrochemical cells formed in the processing pad over the second electrode.

18. The apparatus of claim 17, wherein the first electrode further comprises:
a top surface recessed about 5 to about 80 miles below the polishing surface.

19. The apparatus of claim 17, where the first electrode further comprises:
a protrusion extending partially through an aperture formed through the processing pad.

20. The apparatus of claim 19, wherein the protrusion further comprises:
an upper surface disposed about 30 to about 150 mils above a top surface of the second electrode.

21. The apparatus of claim 17, wherein each of the second electrodes are independently coupled to a power source that independently controls a respective bias applied to each of the cathodic electrochemical cells.

22. The apparatus of claim 17, wherein the first electrode is circumscribed by at least one of the second electrodes.

23. The apparatus of claim 17, wherein the first electrode and the second electrode are rings.

24. The apparatus of claim 17, wherein the first electrode and the second electrode are arranged in an alternating radial pattern.

25. A method for electrochemical processing a substrate, the method comprising:
placing the substrate in contact with a polishing surface of a processing pad having a plurality of apertures formed in the surface;
moving the substrate and the processing pad relative to each other;
creating first conductive paths between anodes and the substrate through a first portion of the apertures;
creating second conductive paths between cathodes and the substrate through second portions of the apertures, wherein the anodes and cathodes are recessed below the polishing surface;
applying a bias through the first conductive path to the substrate; and
selectively polishing a region of the substrate over the second conductive paths.
